(19) United States
(12) Patent Application Publication
(10) Pub. No.: US 2014/0048368 A1
(43) Pub. Date: Feb. 20, 2014

(54) ACTIVE DAMPING SYSTEM FOR A SPRAY BOOM

(71) Applicant: Joergen Maagaard, Vejle (DK)

(72) Inventor: Joergen Maagaard, Vejle (DK)

(73) Assignee: Syddansk Universitet, Odense M (DK)

(21) Appl. No.: 14/113,854

(22) PCT Filed: Apr. 27, 2012
(86) PCT No.: PCT/DK12/50140

§ 371 Date: Oct. 25, 2013

(30) Foreign Application Priority Data
Apr. 29, 2011 (DK) PA 2011 00331

(51) Int. Cl. F16F 15/02; F16F 15/00; B60P 3/30

(52) U.S. Cl. CPC F16F 15/02; B60P 3/30; F16F 15/002
USPC 188/378; 239/726

(57) ABSTRACT

A system comprising a spray boom including a pair of boom assemblies, means for measuring the position of the boom assemblies relative to the ground, a stabilising device mounted on each boom assembly for stabilising and damping vertical movement of the spray boom, activating means connected to the stabilising device, and computer controlling means, wherein the stabilising device is configured as a block movable on a track along the length of the boom assembly thereby displacing the centre of gravity of the spray boom, the activating means capable of moving the block along the boom assembly, the computer controlling means receiving information from the means for measuring the position of the boom assemblies relative to the ground on the vertical movement of the pair of boom assemblies, whereby the computer controlling means controls the vertical position of the stabilising device through the activating means in response to received information.

### FIELD OF THE INVENTION

The present invention relates to a system for stabilising and damping vertical movement of a spray boom connected, preferably pivotably, to a tractor or another vehicle, as used for sprayers in agricultural applications.

### BACKGROUND OF THE INVENTION

Agricultural fields are often sprayed with various chemical solutions, including fertilizers, herbicides, insecticides, etc. Various types of equipment are available for applying such chemical solutions.

Sprayers used in farming for spraying crops, have wide spray booms, in operating position, which extended outwardly transverse to the direction of travel of a vehicle adapted for moving the spray boom. The width of the sprayer typically ranges from 24 metres to 52 metres.

The tendency towards the use of low volume spraying techniques, leading to a necessary reduction in spray droplet size, the cost of chemicals and increasing concern with environmental pollution demand more sophisticated spraying-machines which are able to spray the liquid as uniformly as possible.

A problem with boom spraying equipment relates to difficulties in conforming the spray booms in their field positions to the terrain. These problems are exacerbated by sloping and uneven field conditions, and are further exacerbated by relatively wide-span spray booms which can create relatively large moment arms at the vehicles. For spray chemical coverage, the spray nozzles mounted on the booms should preferably be positioned at uniform heights above the field or crop surface. However, when traversing a sloping field, the boom on one side of the vehicle may need to be raised while the other boom may need to be lowered to maintain a relatively uniform spraying height for effective coverage. This problem has been addressed by providing boom elevation controls, which can be operated for each boom independently from the vehicle cab. However, manually controlled boom elevation systems are susceptible to human error factors in operation. For example, operators may have difficulty adjusting the elevations of a pair of spray booms in response to changing field contours while keeping the vehicle on a straight course.

EP0157592 describes a boom suspension including a passive and an active suspension arrangement. The passive suspension arrangement maintains the boom in a set relation to the vehicle and stabilises the boom against displacement from a desired position when the vehicle moves over uneven ground. The active suspension arrangement comprises means to force an alteration of a dimension of the passive suspension and in that way corrects by displacement of the whole boom and suspension. This is necessary when the boom is in the wrong attitude with respect to the ground surface when, for example, the boom tilts on its own suspension or the ground is sloping. The means to force the alteration produce a final boom position which is altered from the stabilised suspended position. Control means to control the means to force the alteration in the said dimension provide a continuous correction of the displacement more slowly than the stabilisation action of the passive suspension of the whole boom and suspension. This control means include a distance sensor to measure the distance of the boom from the ground, means responsive to this measurement to determine the alteration in the dimension to correct the distance of the boom from the ground, and means responsive to this determination to alter the dimension to continuously correct the distance of the boom from the ground. One problem with this known device is that the fundamental frequency of the boom is low. This means that it reacts very slowly to any attempt to change its inclination to the ground. This slow reaction makes it difficult for the driver of the tractor to estimate exactly how far the boom must be moved—for example changing direction when traversing a sloping field requires that the slope of the boom must be changed as the tractor turns the corner to traverse the slope in the reverse direction. To avoid over-or undershoot, the driver must wait for stabilisation after each adjustment of the boom.

In all known attempts for the problem mentioned above, it is difficult to keep the spray boom parallel to the ground (and thus to the crops to be sprayed) at all times. The boom can oscillate, under the influence of variations in the transverse slope and external forces such as, for example, the wind. This tends to cause its ends to strike the ground and, in any case, disrupts the regularity of spraying.

Spray booms do also oscillate vertically even when the ground is even. Such movement is highly undesired.

U.S. Pat. No. 3,731,879A describes a system for a pivoted spray boom including a pair of boom assemblies. The invention disclosed in U.S. Pat. No. 3,731,879A aims to have the boom parallel to the ground if the tractor is driving on a sloped surface. In U.S. Pat. No. 3,731,879A the driver must adjusts the position of the weights on the boom from inside the tractor, which confirms that U.S. Pat. No. 3,731,879A does not deal with automatic damping of unwanted vibrations.

U.S. Pat. No. 4,522,841A is concerned with the stabilization of vertical movement of a spray boom and not the damping of vibrations in the spray boom. In U.S. Pat. No. 4,522,841A the boom is mounted with complete freedom of movement along its center of gravity, whereby an actuator connected to the boom maintains a spray manifold parallel to the ground. The system disclosed in U.S. Pat. No. 4,522,841A would not allow dampening of boom vibrations due to e.g. an uneven ground surface.

None of these prior art documents discloses a feedback system (with control loop) that would allow sufficiently rapid balancing of rapid vibrations.

Hence, it is still a challenge to dampen undesired vertical vibrations of the boom. There has been a long-felt need for actively damping vertical vibrations of spray booms. Many have attempted to solve that problem with systems similar to those of U.S. Pat. No. 4,522,841A, but without success.

It is an object of the present invention to provide a system that actively damps any undesired vertical movement of a spray boom. In this respect it is also an object to provide an automatic height control system, which can automatically and independently control and adjust the working heights of a pair of boom assemblies, especially relatively wide-span boom assemblies, pivotably attached to a tractor or another vehicle.

### SUMMARY OF THE INVENTION

The above mentioned objects have been solved by the present invention.

In one aspect of the present invention there is provided a system for actively damping vertical movement of a spray boom, said system comprising:
a spray boom including a pair of boom assemblies;
one or more means for measuring the position of the boom assemblies relative to the ground, such as one or more accelerometers, gyros and/or distance measuring appartus;
a stabilising device mounted on each boom assembly for actively stabilising and damping vertical movement of the spray boom;
activating means connected to the stabilising device;
computer controlling means;
   wherein the stabilising device is configured as a block movable on a track along the length of the boom assembly and due to the mass of the block it compensates for any undesired vertical movement, said activating means capable of moving the device along the boom assembly, said computer controlling means receiving information from the one or more means for measuring the position of the boom assemblies on the vertical movement of the pair of boom assemblies, whereby the computer controlling means controls the vertical position of the stabilising device through the activating means in response to the received information (i.e. true feed-back control).

Preferably the block has a mass of at least 15 kg, but 12 kg may also be sufficient. In a particularly preferred embodiment of the present invention the block is moved along the length of the boom (preferably on a rail) by wires or belts. It is also preferred that the means for measuring the position of the boom assemblies is a accelerometer.

In another aspect of the present invention there is provided a method for actively damping vertical movement of a spray boom, said method comprising the steps:
providing a spray boom including a pair of boom assemblies;
providing one or more one or more means for measuring the position of the boom assemblies relative to the ground, such as one or more accelerometers, gyros and/or distance measuring appartus;
providing a stabilising device mounted on each boom assembly for actively stabilising and damping vertical movement of the spray boom;
moving the stabilising device, which is configured as a block with a mass of at least 12 kg, on a track along the length of the boom assembly in response to undesired vertical movement of the spray boom.

### BRIEF DESCRIPTION OF THE DRAWINGS

FIG. 1 shows a 30 meter Spraying boom partly unfolded.

FIG. 2 shows an accelerometer sensor box placed on second outer boom section

FIG. 3 shows a diagrammatic illustration of the stabilising device of the present invention.

FIG. 4 shows a function diagram of a hydraulic motor and p-valve useful in the present invention.

### DETAILED DESCRIPTION OF THE INVENTION

The invention will be explained hereinafter with respect to certain embodiments and drawings. The present invention will mainly be described with reference to agricultural spray booms, but the present invention may be applied to any suspended boom system, e.g. spraying of paints or other liquids.

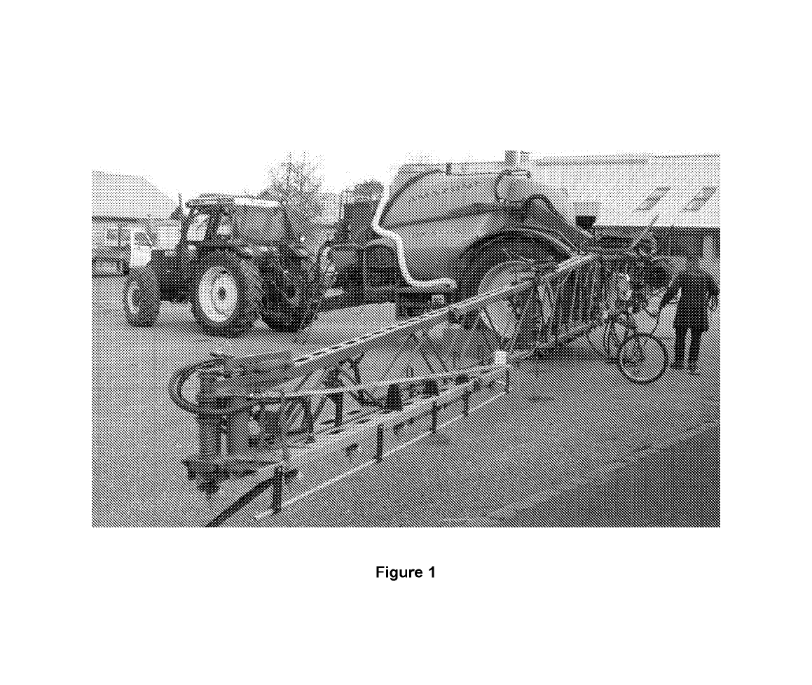

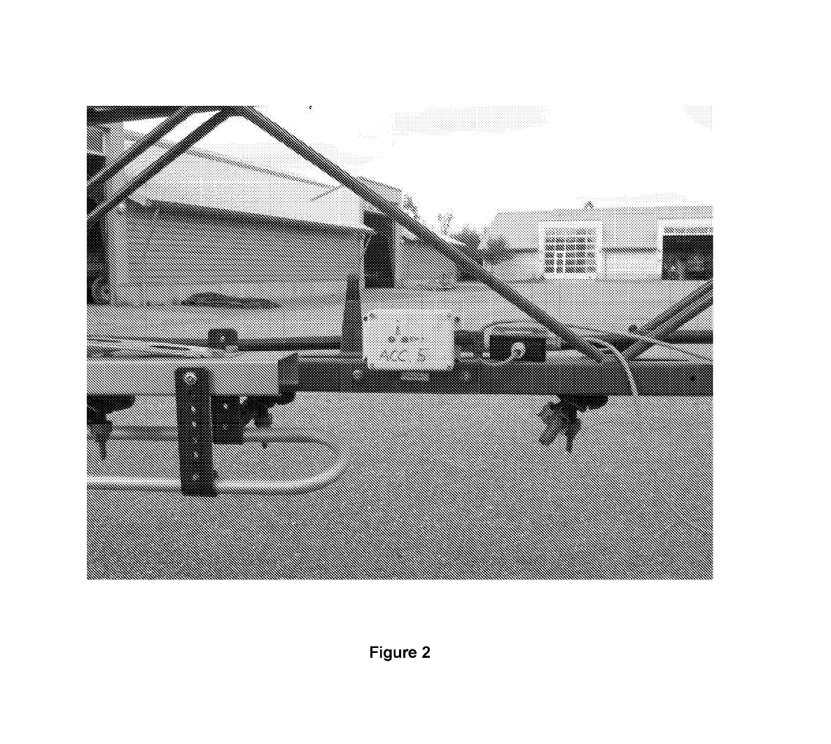

Referring to FIG. 1 there is shown a spray boom including a pair of boom assemblies. In FIG. 2 there is shown an accelerometer mounted on the boom. The accelerometer measures the position of the boom assembly relative to the ground, and in response thereto the stabilising device is moved along the boom assembly to compensate for any undesired vertical movement of the spray boom; this is all regulated through the computer controlling means, which receives information on the vertical movement from the accelerometer and activates activating means (e.g. by simple feed-back regulation) to ensure that the stabilising device (e.g. a block movable on a track along the length of the boom assembly) due to its mass compensates for any undesired vertical movement.

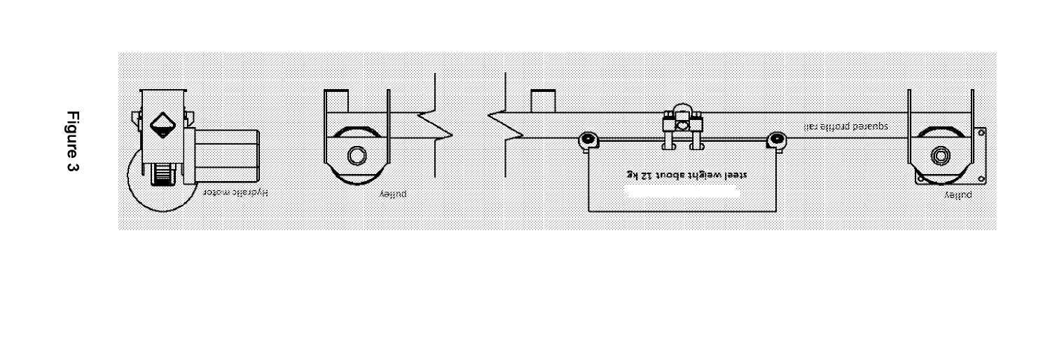

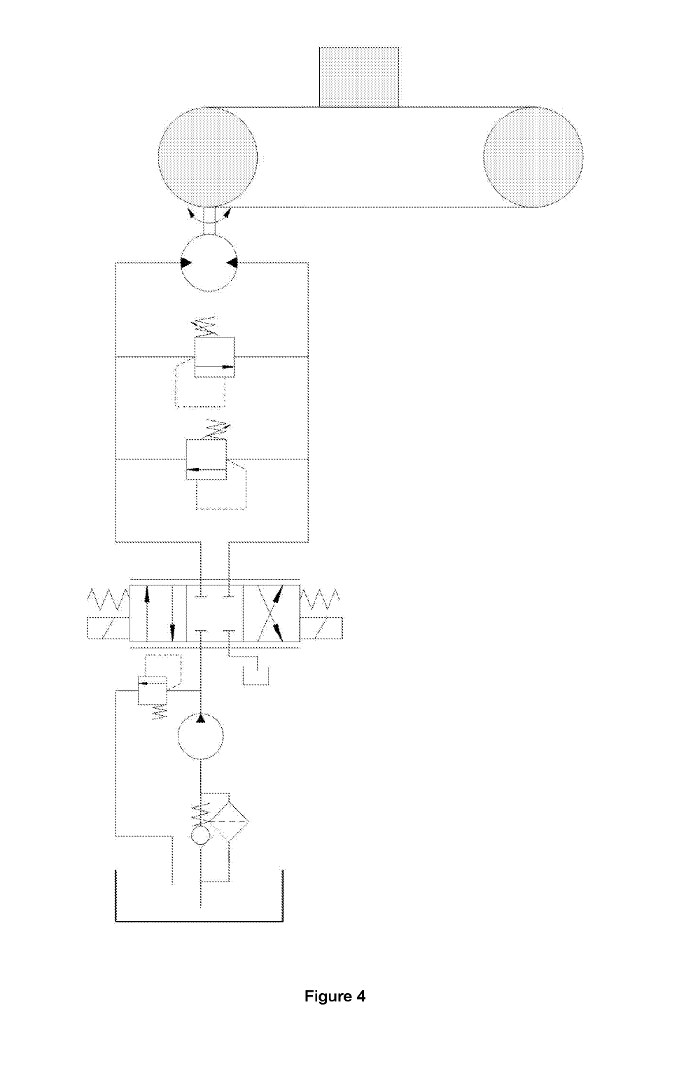

When working in the field, the vertical vibration of the boom is measured by the accelerometer. The stabilising device is mounted just before the outer boom section on left and right side on the top frame of the boom. The length of the rail (a squared profile) should have nearly the same width as the boom section (see FIG. 3). The stabilising device in the embodiment shown in FIG. 3 is a block moved along the squared profile by use of hydraulic motor and a timing belt; a functional diagram of this set-up is shown in FIG. 4.

1. A system for actively damping vertical movement of a spray boom, said system comprising:
a spray boom comprising a pair of boom assemblies;
one or more means for measuring the position of the boom assemblies relative to the ground, such as one or more accelerometers, gyros and/or distance measuring appartus;
a stabilising device mounted on each boom assembly for actively stabilising and damping vertical movement of the spray boom;
activating means connected to the stabilising device;
computer controlling means;
wherein the stabilising device is configured as a block movable on a track along the length of the boom assembly and due to the mass of the block it compensates for any undesired vertical movement, said activating means capable of moving the device along the boom assembly, said computer controlling means receiving information from the one or more means for measuring the position of the boom assemblies relative to the ground on the vertical movement of the pair of boom assemblies, whereby the computer controlling means controls the vertical position of the stabilising device through the activating means in response to the received information.

2. System according to claim 1, wherein the block has a mass of at least 12 kg, such as at least 15 kg, and wherein the movement of the block on each boom assembly is synchroneous.

3. System according to claim 1, wherein the block is moved along the length of the boom by wires or hydraulic drives.

4. System according to claim 1, wherein the accelerometers are placed on the next outer sections of the boom assemblies.

5. System according to claim 1, wherein the spray boom is suspended from a frame on or connected to a tractor or another vehicle, as used for sprayers in agricultural applications.

6. A method for actively damping vertical movement of a spray boom, said method comprising the steps:
providing a spray boom comprising a pair of boom assemblies;
providing one or more accelerometers;
providing a stabilising device mounted on each boom assembly for actively stabilising and damping vertical movement of the spray boom;
moving the stabilising device, which is configured as a block with a mass of at least 12 kg, such as at least 30 kg, on a track along the length of the boom assembly in response to undesired vertical movement of the spray boom.

7. Method according to claim 6, wherein the block is moved along the length of the boom by wires or hydraulic drives.

8. Method according to claim 6, wherein the accelerometers are placed on the outer sections of the boom assemblies.
